(19) United States
(12) Patent Application Publication
(10) Pub. No.: US 2016/0224639 A1
(43) Pub. Date: Aug. 4, 2016

(54) SYSTEM AND METHOD FOR THE TIME DOMAIN PRESENTATION OF TEXT DATA

(71) Applicant: Bruce F. PETTIT, Webster, TX (US)

(72) Inventor: Bruce Frederick Pettit, Webster, TX (US)

(21) Appl. No.: 15/021,361

(22) PCT Filed: Sep. 15, 2014
(86) PCT No.: PCT/US2014/055623

§ 371 Date: Mar. 11, 2016

Related U.S. Application Data
(60) Provisional application No. 61/960,270, filed on Sep. 16, 2013.

(51) Int. Cl. G06F 17/30

(52) U.S. Cl. CPC G06F 17/30551; G06F 17/30554

(57) ABSTRACT

The present disclosure relates to the field of systems, processes and methods for the time domain presentation of text data. A method and apparatus for coding text in a manuscript for creating a one-to-one relationship between the text and a digital array. The method of coding text in a manuscript creates a one-to-one relationship between the text and the digital array. A method and apparatus for coding Bible verses for creating a one-to-one relationship between the verse and the time thereby creating a unique combination of verse and time. The method provides for coding text from the Holy Bible for creating a one-to-one relationship between the text and an array.

### CROSS REFERENCE TO RELATED APPLICATIONS

This application claims priority to U.S. Prov. App. No. 61/960,270, filed on Sep. 16, 2013 which is incorporated by reference herein in its entirety.

### FIELD

The present disclosure relates to the field of systems and methods for the time domain presentation of text data. More particularly, the present disclosure relates to a system and method for creating a one-to-one relationship between text and an array comprising a plurality of digits associated with a clock. Still further, the present disclosure relates to associating the text of verses from numerically valued books, chapters and versus of texts with a digital array of the clock for creating a unique combination of verse and time.

### BACKGROUND

Time displays having message areas on the display that cite specific text are known. For example, some PDAs have apps or other software to allow a user to insert scripture references, prayer requests, prayers and other journal entries for ready reference. However, the need for specific bibliographic references corresponding to every specific date still exists.

In terms of religious texts, humorous anecdotes such as jokes, proverbs from various philosophers and other figures, desktop calendars, clocks and web pages can provide this information. The information is often random, for example, typically, there is no particular association between a date or a time and a particular textual phrase. In some cases, there are even wristwatches that display a message when randomly activated by movement of the user's arm. However, no bibliographic reference is displayed with the reference. Not only are these texts typically random, they do not allow a user to examine the text and look it up in a book and the like.

Regarding religious texts, such as from the Christian Bible, the Quran, and various Hindu, Buddhist and other books, internet sites can provide a random verse for each time a person visits the website. Naturally, in certain instances, the website can have a particular group of texts for a certain time of year. As an example, if a user were to visit such a site around Christmas, the website could display chapters or verses associated with the birth of Jesus.

Also, wristwatches exist with GPS capabilities and an imbedded chip to calculate and display the correct times for prayer for Muslims and to indicate the direction toward Mecca. The face of the dial changes color depending on the prayer to be offered. Only the time for prayer and direction toward Mecca are provided and thus there is still a need for specific bibliographic references corresponding to each date of each month.

However, none of the aforementioned devices provides a unique combination of words and numbers such as can be found in the Book of Mormon or Bible and then associates the texts with an array of digits. Moreover, in either the case of a calendar date or a clock date, a random association of digits corresponding to a chapter and verse can render a result that is either not inspirational or that is somewhat meaningless out of a larger context. Further, in the case of a calendar, there is a limit of only the first twelve chapters of a given book in the bible and a limit of up to thirty one versus from any of the first twelve chapters in a given book. Additionally, if instead of a calendar, a clock time is used, there are a limited number of chapters in the Bible with more than forty versus. Thus, without adequate methods, any correlation between a biblical verse, either using a twelve hour clock or a twenty four hour clock would be limited to a few books and chapters within the Bible, thereby preventing inspirational passages from being presented.

### SUMMARY

A feature of the present disclosure is to provide a method and apparatus for associating the text of the verse from the Bible or other religious texts having numbered verses with the digital array of the clock for creating a unique combination of verse and time.

Another feature of the present disclosure is to provide a method and apparatus for associating the text with the four-digit array for creating a unique combination of words and numbers.

Another feature of the present disclosure is to provide a scripture clock showing direct numerical correlations between the 1440 one minute time intervals in a given day to chapters and verses of the Holy Bible.

Another feature of the present disclosure is to provide an advertising clock, where for each one minute time interval the viewer sees a different narrative display, perhaps a recipe, a historical anecdote, etc.

Yet still another feature of the present disclosure is to provide a method and apparatus that offers the viewer a powerful, direct numerical connection between digital time intervals and chapters and verses from scripture.

Yet still another feature of the present disclosure is to provide a method and apparatus for providing “scripture mail” where your outgoing emails automatically display a piece of scripture related to the time interval the email was sent.

The features disclosed herein further will offer strong emotional appeal. In many instances, people will get satisfaction from using a scripture clock or scripture mail often and will develop a strong connection with the device.

Yet another feature of the present disclosure is to provide a method and apparatus for creating a direct numerical correlation concept of digital time intervals to chapter and verse numbers of the Bible.

Yet still another feature of the present disclosure is to provide a method and apparatus for offering wisdom and emotional support in one-minute intervals.

Yet still another feature of the present disclosure is to provide a method and apparatus where time as a direct connection to scripture.

Another feature of the present disclosure is to provide a method and apparatus for use as a screen saver.

Another feature of the present disclosure is to provide a method and apparatus adaptable for use with smart phones.

Another feature of the present disclosure is to provide a method and apparatus adaptable for use with respect to scripture mail, e.g., for the time received, a matching scripture will be provided below the signature line of an email.

Another feature of the present disclosure is to provide a method and apparatus adapted for use as a scripture watch.

And yet still another feature of the present disclosure is to provide a method and apparatus for coding text in a manuscript for creating a one-to-one relationship between the text and a four-digit array. Certain embodiments of the invention pertain to an improved process of transferring electronic data comprising numerically coded texts associated corresponding to time of day, the process comprising an electronic clock initiated transfer of electronic data to a processor operatively connected to an electronic database, the data comprising a four digit value of time of day corresponding to a time of day generated by the clock, each digit itself comprising a numerical value to an electronic database; wherein

a first digit as read from left to right consists of an integer value of 0, 1, or 2;

a second digit as read from left to right consists of an integer value of 0 to 9;

a third digit as read from left to right consists of an integer value of 0 to 9;

a fourth digit as read from left to right consists of an integer value of 0 to 9; and

wherein the database comprises electronic data; the electronic data itself comprising at least 1440 numerically coded texts; the numerically coded texts each comprising a four digit numerical value; wherein

a first digit associated with a text as read from left to right consists of an integer value of 0, 1, or 2;

a second digit associated with the same text as read from left to right consists of an integer value of 0 to 9;

a third digit associated with the same text as read from left to right consists of an integer value of 0 to 9;

a fourth digit associated with the same text as read from left to right consists of an integer value of 0 to 9; and

a processor initiated transfer of electronic data comprising selecting a numerically coded text from the database to an electronic graphical interface, the numerically coded text being the same value as the four digit time of day, and wherein the text is displayed on the electronic graphical display, and wherein the processor selects the numerically coded texts during the time of day generated by the clock.

As can be readily ascertained, the selection of the numerous texts in such a short amount of time, wherein the time is often a few seconds, is impossible to do without a computer processor searching through an electronic database.

In these embodiments, the numerically coded texts comprises a book of a Bible or Book of Mormon (BOM), a chapter of the Bible or BOM within said book and a verse of the Bible or BOM within said chapter. Still further, the books of the Bible or BOM correspond to a numerical value of 0, 1, 2, 3 or 4 and wherein: A) books of the Bible or BOM having numerical value of 1 are: 1 Kings, 1 Chronicles, 1 Corinthians, 1 Thessalonians, 1 Timothy, 1 Peter, 1 John, 1 Esdras, 1 Maccabees, and 1 Nephi; B) books of the Bible or BOM having an integer value of 2 are: 2 Kings, 2 Chronicles, 2 Corinthians, 2 Thessalonians, 2 Timothy, 2 Peter, 2 John, 2 Esdras, 2 Maccabees, and 2 Nephi; C) books of the Bible or BOM having an integer value of 3 are: 3 John, 3 Maccabees, and 3 Nephi; D) books of the Bible or BOM having an integer value of 4 are: 4 Maccabees and 4 Nephi; and E) all other books of the bible have an integer value of 0.

In the embodiments herein, wherein when the processor selects a book, chapter and verse combination from the electronic database to associate this combination with the time of day, the processor searches for:

a book of the Bible or BOM having a numerical value of a 1 or a 2 and further wherein

if the book has a numerical value of 1, then the second digit of the four digit value of time is a first digit of any numerical chapter of the book having less than three digits and wherein:

if the chapter of the book is a single digit chapter, then

the numerical value of the single digit chapter is 1, 2, 3, 4, 5, 6, 7, 8, or 9; and

the third and fourth digits of the four digit value of time are selected from a two digit verse of the book, the first digit of the two digit verse having a numerical value of 1, 2, 3, 4, or 5 and the second digit having any numerical value; or

if the numerical chapter of the book is a two digit chapter, then

the first digit of the two digit chapter has a numerical value of 1, 2, 3, 4, 5, 6, 7, 8, or 9;

the second digit of the two digit chapter, corresponding to the third digit of the four digit value of time has a numerical value of 0, 1, 2, 3, 4 or 5; and

the fourth digit of the four digit value of time is a single digit verse of said chapter having a numerical value of 1, 2, 3, 4, 5, 6, 7, 8 or 9; or

if the book has a value of 2, then the second digit of the four digit value of time is a first digit of any numerical chapter of the book having less than three digits and wherein:

if the numerical chapter of the book is a single digit chapter, then

the numerical value of the single digit chapter is 1, 2, or 3;

the third and fourth digits of the four digit value of time are selected from a two digit verse, the first digit of the two digit verse having a numerical value of 1, 2, 3, 4, or 5; and

the second digit of the two digit verse has any single digit numerical value; or

if the numerical chapter of the book is a two digit chapter, then

the first digit of the two digit chapter has a numerical value of 1, 2, or 3;

the second digit of the two digit chapter, corresponding to the third digit of the four digit value of time has a numerical value of 0, 1, 2, 3, 4 or 5; and

the fourth digit of the four digit value of time is a single digit verse of said chapter having a numerical value of 1, 2, 3, 4, 5, 6, 7, 8, or 9; or

a book of the Bible or BOM having a value of 0 wherein:

a chapter and verse selection correspond to a four digit value of time and the chapter has at least a first digit having a numerical value of 1 or 2 corresponding to the first digit of the four digit value of time, and wherein:

if the chapter is a single digit chapter, then the next three digits correspond to a three digit verse of the chapter, with the proviso that if the single digit has a numerical value of 2, then the first digit of the verse has a numerical value of 1, 2, or 3, and the second digit of the verse has a numerical value of 1, 2, 3, 4 or 5;

if the chapter is a two digit chapter, then

if the first digit of the two digit chapter has a numerical value of 1, then the second digit of the chapter is any digit and

the next two digits correspond to a two digit verse of the chapter, the wherein the first digit of the two digit verse has a numerical value of 1, 2, 3, 4, or 5;

if the chapter is a three digit chapter, then:

the first digit of the chapter has a numerical value of 1;

the second digit of the chapter has a numerical value of 1, 2, 3, 4, or 5;

the third digit of the chapter has a numerical value of 1, 2, 3, 4 or 5; and

the fourth digit corresponds to a single digit verse of the chapter having a numerical value of 1, 2, 3, 4, 5, 6, 7, 8, or 9

the first digit is a 0 value of the book and a chapter and verse selection correspond to a three additional digits of the value of time wherein:

the chapter is a single digit chapter and has a numerical value of 1, 2, 3, 4, 5, 6, 7, 8 or 9; and the next two digits correspond to a two digit verse of the chapter, the wherein the first digit of the two digit verse has a numerical value 1, 2, 3, 4, or 5 and the second digit of the two digit verse has any single digit value; or

the chapter is a two digit chapter, and wherein

the first digit of the chapter is a 1, 2, 3, 4, 5, 6, 7, 8, or 9

the second digit of the chapter is a 1, 2, 3, 4, or 5; and

the third digit is a single digit verse of the chapter and has a value of 1, 2, 3, 4, 5, 6, 7, 8 or 9;

a book of the Bible having a value of 3 or 4 wherein a chapter and verse selection correspond to the next three digits of the four digit value of time, and wherein the chapter is a single digit chapter having a numerical value of 1, 2, 3, 4, or 5 and the verse is a single verse with a numerical value of 1, 2, 3, 4, 5, 6, 7, 8 or 9 and

wherein no combination of values of chapter or verse is selected if said chapter or verse does not exist a selected book.

In still further embodiments the processor searches for texts comprising a combination of numerical values of a book, chapter, and verse corresponding to a subject comprising Jesus's birth during December, and presents the texts on the graphical display if the combination of numerical values is able to correspond to the value of time needed. Likewise, processor searches for texts comprising a combination of numerical values of a book, chapter, and verse corresponding to a subject comprising Jesus's death and resurrection during March or April and presents the texts on the graphical display if the combination of numerical values is able to correspond to the value of time needed.

Other objects, features and advantages of the present invention will become apparent from the following detailed description. It should be understood, however, that the detailed description and the specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

In order that the manner in which the above-recited and other enhancements and objects of the invention are obtained, we briefly describe a more particular description of the invention briefly rendered by reference to specific embodiments thereof which are illustrated in the appended drawings. Understanding that these drawings depict only typical embodiments of the invention and are therefore not to be considered limiting of its scope, we herein describe the invention with additional specificity and detail through the use of the accompanying drawings in which:

FIG. 1 is a flow chart that illustrates one embodiment of the system and method for the time domain presentation of text data for use with a manuscript.

FIG. 2 is a flow chart that illustrates another embodiment of the system and method for the time domain presentation of text data for use with a manuscript.

FIG. 3 is a flow chart that illustrates another embodiment of the system and method for the time domain presentation of text data for use with the Holy Bible.

FIG. 4 is a flow chart that illustrates another embodiment of the system and method for the time domain presentation of text data for use with the Holy Bible.

FIG. 5 is a flow chart that illustrates yet another embodiment of the system and method for the time domain presentation of text data for use with the Holy Bible.

FIG. 6 is a flow chart that illustrates yet still another embodiment of the system and method for the time domain presentation of text data for use with the Holy Bible.

FIG. 7 is a flow chart that illustrates another embodiment of the system and method for the time domain presentation of text data for use with a manuscript.

FIG. 8 is a flow chart that illustrates still another embodiment of the system and method for the time domain presentation of text data for use with the Holy Bible.

FIG. 9 is a flow chart that illustrates still another embodiment of the system and method for the time domain presentation of text data for use with the Holy Bible.

FIG. 10 illustrates a display explaining the time and text data presented by the system and method of the present disclosure with respect to the direct numerical relationship between the time interval, on one hand, and the chapter and verse from the Holy Bible, on the other hand.

FIG. 11 illustrates another display of the system and method of the present disclosure with respect to the direct numerical relationship between the time interval, on one hand, and the chapter and verse from the Holy Bible, on the other hand.

FIG. 12 illustrates yet another display of the system and method of the present disclosure with respect to the direct numerical relationship between the time interval, on one hand, and the chapter and verse from the Holy Bible, on the other hand.

FIG. 13 illustrates a digital clock display of another system and method of the present disclosure with respect to the direct numerical relationship between the time interval, on one hand, and the chapter and verse from the Holy Bible, on the other hand.

FIG. 14 illustrates a display explaining the time and text data presented by the system and method of the present disclosure with respect to the direct numerical relationship between the time interval, on one hand, and the chapter and verse from the Holy Bible, on the other hand.

FIG. 15 illustrates another display of the system and method of the present disclosure with respect to the direct numerical relationship between the time interval, on one hand, and the chapter and verse from the Holy Bible, on the other hand.

FIG. 16 illustrates yet another display of the system and method of the present disclosure with respect to the direct numerical relationship between the time interval, on one hand, and the chapter and verse from the Holy Bible, on the other hand.

FIG. 17 illustrates a display explaining the time and text data presented by the system and method of the present disclosure with respect to the direct numerical relationship between the time interval, on one hand, and the chapter and verse from the Holy Bible, on the other hand, as well as the relationship of the one-to-one correlation between each interval of time and a specific scripture from the Holy Bible.

FIG. 18 illustrates a display of time and text data presented by the system and method of the present disclosure with respect to the direct numerical relationship between the time interval, on one hand, and the chapter and verse from the Holy Bible, on the other hand.

FIG. 19 illustrates yet another display of time and text data presented by the system and method of the present disclosure with respect to the direct numerical relationship between the time interval, on one hand, and the chapter and verse from the Holy Bible, on the other hand.

FIG. 20 illustrates yet another display of time and text data presented by the system and method of the present disclosure with respect to the direct numerical relationship between the time interval, on one hand, and the chapter and verse from the Holy Bible, on the other hand.

FIG. 21 illustrates another display of time and text data presented by the system and method of the present disclosure with respect to the direct numerical relationship between the time interval, on one hand, and the chapter and verse from the Holy Bible, on the other hand.

FIG. 22 illustrates another display of time and text data presented by the system and method of the present disclosure with respect to the direct numerical relationship between the time interval, on one hand, and the chapter and verse from the Holy Bible, on the other hand.

FIG. 23 illustrates yet another display of time and text data presented by the system and method of the present disclosure with respect to the direct numerical relationship between the time interval, on one hand, and the chapter and verse from the Holy Bible, on the other hand.

FIG. 24 illustrates still another display of time and text data presented by the system and method of the present disclosure with respect to the direct numerical relationship between the time interval, on one hand, and the chapter and verse from the Holy Bible, on the other hand.

FIG. 25 illustrates still another display of time and text data presented by the system and method of the present disclosure with respect to the direct numerical relationship between the time interval, on one hand, and the chapter and verse from the Holy Bible, on the other hand.

FIG. 26 illustrates still another display of time and text data presented by the system and method of the present disclosure with respect to the direct numerical relationship between the time interval, on one hand, and the chapter and verse from the Holy Bible, on the other hand.

FIG. 27 illustrates a display of time and text data presented by the system and method of the present disclosure with respect to the direct numerical relationship between the time interval, on one hand, and the chapter and verse from the Holy Bible, on the other hand.

### DETAILED DESCRIPTION

We show the particulars shown herein by way of example and for purposes of illustrative discussion of the preferred embodiments of the present invention only. We present these particulars to provide what we believe to be the most useful and readily understood description of the principles and conceptual aspects of various embodiments of the invention. In this regard, we make no attempt to show structural details of the invention in more detail than is necessary for the fundamental understanding of the invention. We intend that the description should be taken with the drawings. This should make apparent to those skilled in the art how the several forms of the invention are embodied in practice.

As used herein, the term Bible is used interchangeably with the term “Holy Bible”. We intend that the Bible is the Christian Bible as used by Christian Churches. We intend that the Bible be any Bible version used by a Christian Church, which may or may not include apocrypha, depending on the Christian denomination, such as Methodist, Anglican, Coptic, Catholic and Orthodox. We intend that any version of the Bible can be used, such as, but not limited to the King James Version, the New International Version and the like. We further intend that the Bible can be in any translation such as, but not including, English, Spanish, Italian, Russian, Korean, Greek and the like. We also contemplate that in some embodiments, the Book of Mormon can be used if the user of the scripture delivery system based on time is a Mormon or wishes to read Mormon scripture. We also contemplate that the embodiments herein can be applied to other religions having numerical values for religious texts.

In one embodiment, the present invention provides a method of coding Bible verses for creating a one-to-one relationship between the verse and the time thereby creating a unique combination of verse and time. The method provides for coding text from the Holy Bible for creating a one-to-one relationship between the text and an array. The array comprises a plurality of digits associated with a clock for showing the time. The text is divided into chapter and verse for association with the digits in the array. The chapter and the verse each have a numerical value. The method comprises the steps of (a) selecting a verse from a chapter from the text of the Holy Bible, (b) determining the number of digits associated with the value of the selected verse, (c) placing the digits associated with the value of the selected verse in at least one of the digits of the array, (d) determining the number of digits associated with the value of the selected chapter, (e) placing the digits associated with the value of the selected chapter in at least one of the digits of the array, and (f) associating the text of the verse from the Holy Bible with the digital array of the clock for creating a unique combination of verse and time.

The method further comprises the step of associating a preselected verse with the digital array if the steps of selecting and determining fail to completely fill the digit array for any specific time.

In another embodiment, the present invention provides a method of coding text in a manuscript for creating a one-to-one relationship between the text and a four-digit array. The method of coding text in a manuscript creates a one-to-one relationship between the text and a four-digit array. The text is divided into chapter and verse for association with the four-digit array. The chapter and the verse each have a numerical value. The four-digit array has the first digit in the right most position of the array, the second digit adjacent to and to the left of the first digit, the third digit adjacent to and to the left of the second digit, and the fourth digit adjacent to and to the left of the third digit. The other method comprises the steps of selecting a verse from a chapter from the text, and determining the number of digits associated with the value of the selected verse. If the value associated with the selected verse is a single digit, then the value is placed in the first digit of the array and a zero in the second digit of the array. If the value associated with the selected verse has two digits, then the two-digit value is placed in the first and second digits of the array. If the value associated with the selected verse has three digits, then the three-digit value is placed in the first, second and third digits of the array.

The value associated with the selected chapter is determined. The value associated with the selected chapter is placed in the remaining digits of the array, and if there are insufficient digits remaining in the array for accepting the value associated with the chapter, then the chapter value is truncated so it can be accepted in the available digits of the array.

The text is associated with the four-digit array for creating a unique combination of words and numbers.

Further, the method of coding text in a manuscript for creating a one-to-one relationship between the text and a four digit array comprises the step of associating a preselected verse with the four digit array if the steps of selecting and determining fail to completely fill the four digit array.

Still further, the method of coding text in a manuscript for creating a one-to-one relationship between the text and a four-digit array provides that the manuscript is the Holy Bible.

Yet still further, the method of coding text in a manuscript for creating a one-to-one relationship between the text and a four-digit array provides that the four-digit array is the digital time associated with a clock.

In yet another embodiment, the present invention provides a method of coding text in a manuscript for creating a one-to-one relationship between the text and a four digit array. The method of coding text in a manuscript for creating a one-to-one relationship between the text and a four-digit array is provided. The text is divided into chapter and verse for association with the four-digit array. The chapter and the verse each have a numerical value. The four-digit array has the first digit in the right most position of the array, the second digit adjacent to and to the left of the first digit, the third digit adjacent to and to the left of the second digit, and the fourth digit adjacent to and to the left of the third digit. The method comprises the following steps. A verse is selected from a chapter from the text. The number of digits is associated with the value of the selected verse. If the value associated with the selected verse is a single digit then, the value is placed in the first digit of the array. If the value associated with the selected verse is two digits then, the value is placed in the first and second digits of the array. If the value associated with the selected verse is three digits then, the value is placed in the first, second and third digits of the array. The number of digits associated with the value of the selected chapter is determined.

The value of the selected chapter is placed in the available digit or digits of the array. If the number of digits associated with the value of the selected chapter exceeds the number of available digits in the array, then the trailing digits of the value of the selected chapter are truncated to accommodate the available digit or digits of the array.

The text is associated with the four-digit array for creating a unique combination of words and numbers. Particularly, for example, at 1:15 am, the viewer of the scripture clock timepiece sees not only the digital time (1:15 am), but time in the form of scripture (1 John 1:5), in a direct numerical relationship between the time interval and chapter and verse from the Holy Bible. For each time interval in the 24 hour day (1440), the viewer of the scripture clock timepiece sees not only the digital time, 1440 times per day, but time in the form of scripture (1440 scriptures), in a direct numerical relationship between the time interval and chapter and verse from the Holy Bible.

Further, the method of coding text in a manuscript for creating a one-to-one relationship between the text and a four digit array further comprises the step of associating a preselected verse with the four-digit array if the steps of selecting and determining fail to completely fill the four digit array.

Still further, the method of coding text in a manuscript for creating a one-to-one relationship between the text and a four-digit array provides that the manuscript is the Holy Bible.

Yet still further, the method of coding text in a manuscript for creating a one-to-one relationship between the text and a four-digit array provides that the four digit array is the digital time associated with a clock.

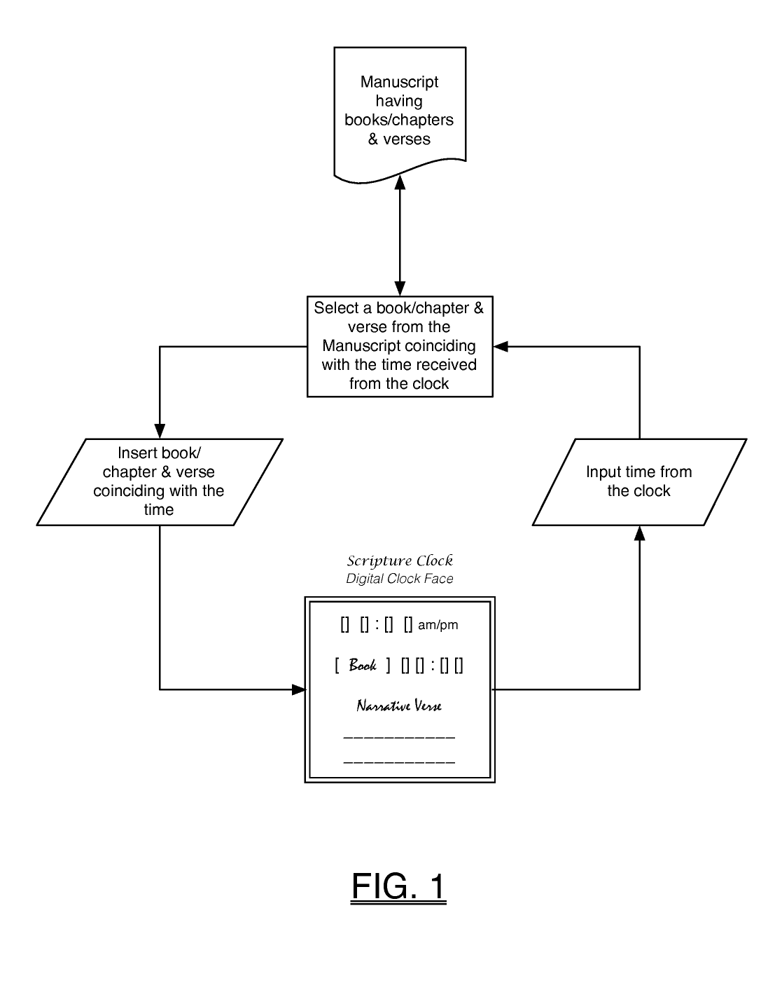

FIG. 1 is a flow chart that illustrates one embodiment of the system and method for the time domain presentation of text data for use with a manuscript. A manuscript is provided having chapters and verses. The clock provides the time that is used to select a corresponding verse from the manuscript. The selected verse from the manuscript has a predefined number designator. The predefined number designator for the verse is used as the time on the clock. Particularly, for example, at 1:15 am, the viewer of the scripture clock timepiece sees not only the digital time (1:15 am), but time in the form of scripture (1 John 1:5), in a direct numerical relationship between the time interval and chapter and verse from the Holy Bible. For each time interval in the 24 hour day (1440), the viewer of the scripture clock timepiece sees not only the digital time, 1440 times per day, but time in the form of scripture (1440 scriptures), in a direct numerical relationship between the time interval and chapter and verse from the Holy Bible.

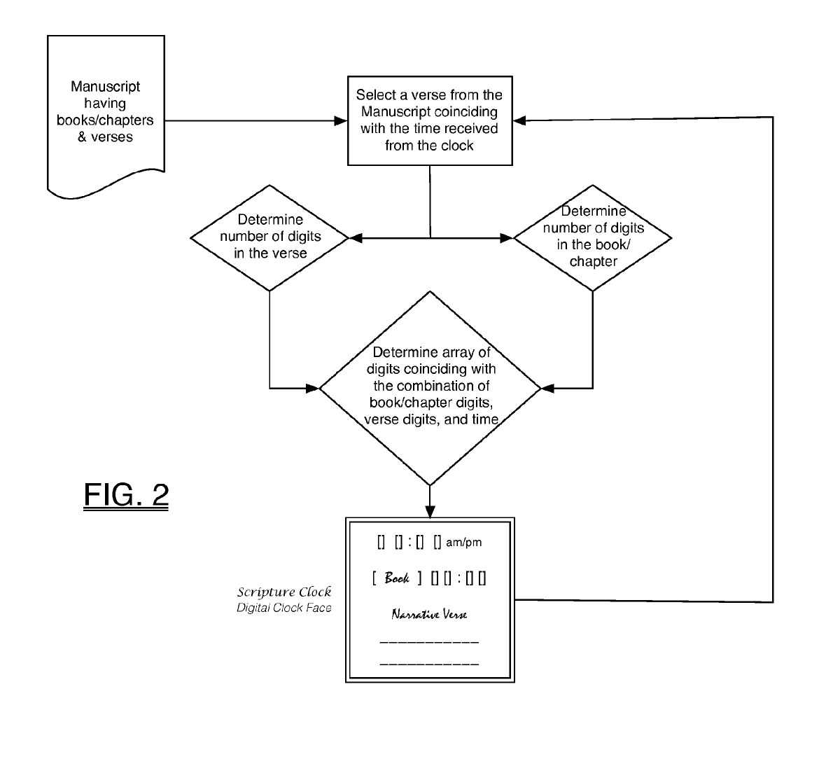

FIG. 2 is a flow chart that illustrates another embodiment of the system and method for the time domain presentation of text data for use with a manuscript. A manuscript is provided having chapters and verses. The clock provides the time that is used to select a corresponding verse from the manuscript, or vice versa. The number of digits in the verse is determined. The number of digits in the chapter is determined. The selected verse and chapter digits are placed in an array. The array is used as and corresponds to the time.

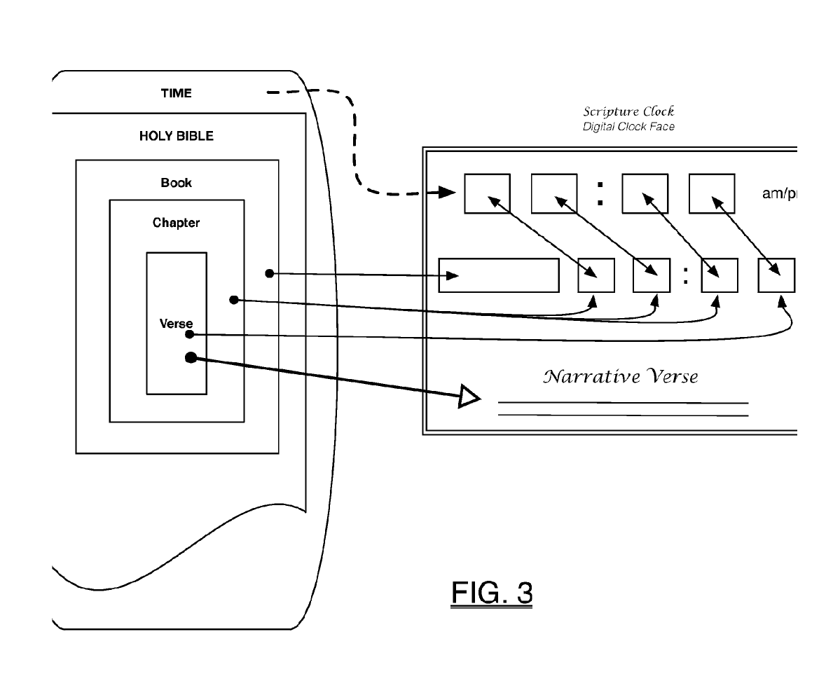

FIG. 3 is a flow chart that illustrates another embodiment of the system and method for the time domain presentation of text data for use with the Holy Bible. FIG. 3 illustrates the use of a three-digit chapter number and a one-digit verse number. The three-digit chapter number is placed in the first three locations, from left to right, of the clock display. The verse is provided in association with the chapter and verse of the particular scripture. Particularly, for example, at 1:15 am, the viewer of the scripture clock timepiece sees not only the digital time (1:15 am), but time in the form of scripture (1 John 1:5), in a direct numerical relationship between the time interval and chapter and verse from the Holy Bible. For each time interval in the 24 hour day (1440), the viewer of the scripture clock timepiece sees not only the digital time, 1440 times per day, but time in the form of scripture (1440 scriptures), in a direct numerical relationship between the time interval and chapter and verse from the Holy Bible.

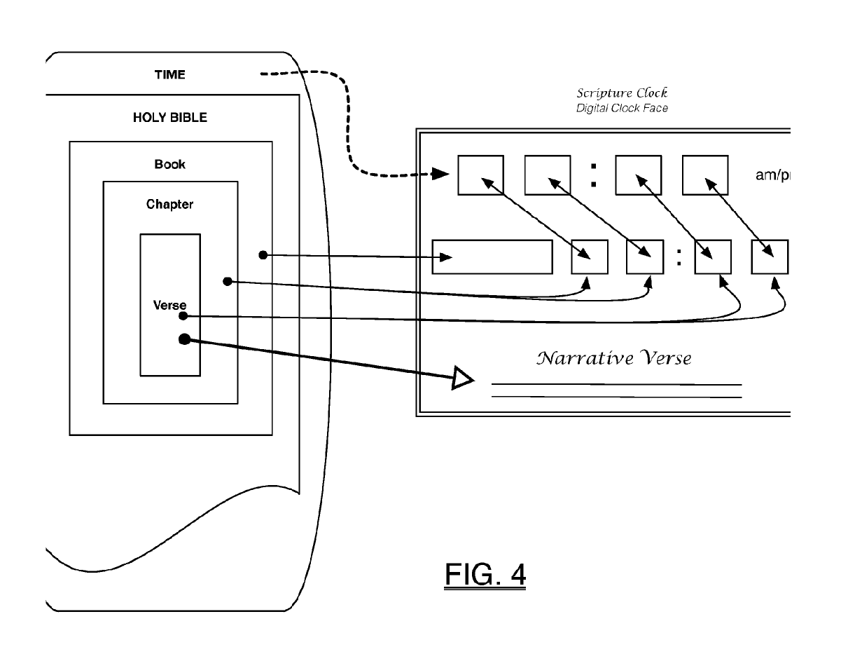

FIG. 4 is a flow chart that illustrates another embodiment of the system and method for the time domain presentation of text data for use with the Holy Bible. FIG. 4 illustrates the use of a two-digit chapter number and a two-digit verse number. The two-digit chapter number is placed in the first two locations, from left to right, of the clock display. The verse is provided in association with the chapter and verse of the particular scripture.

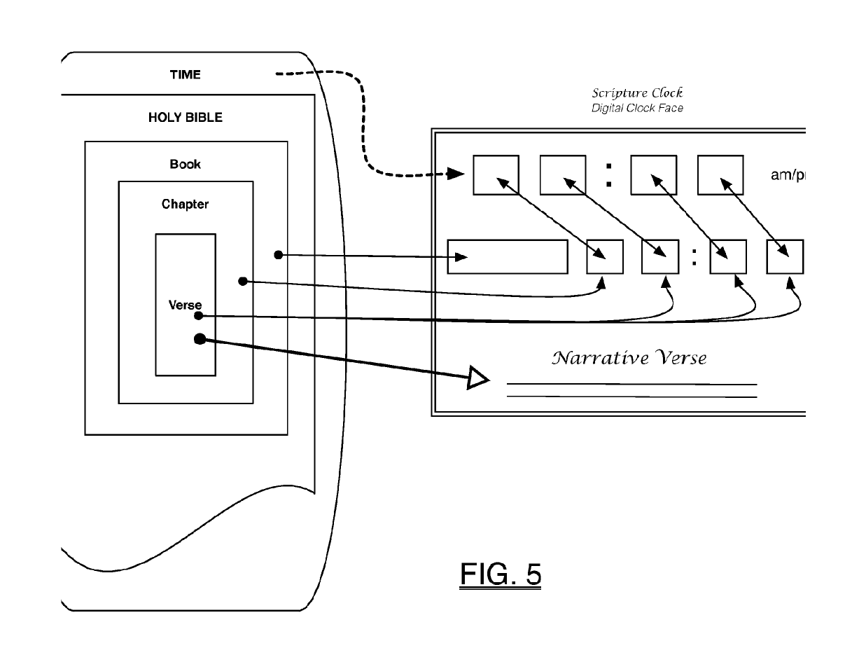

FIG. 5 is a flow chart that illustrates yet another embodiment of the system and method for the time domain presentation of text data for use with the Holy Bible. FIG. 5 illustrates the use of a one-digit chapter number and a three-digit verse number. The one-digit chapter number is placed in the first location, from left to right, of the clock display. The verse is provided in association with the chapter and verse of the particular scripture.

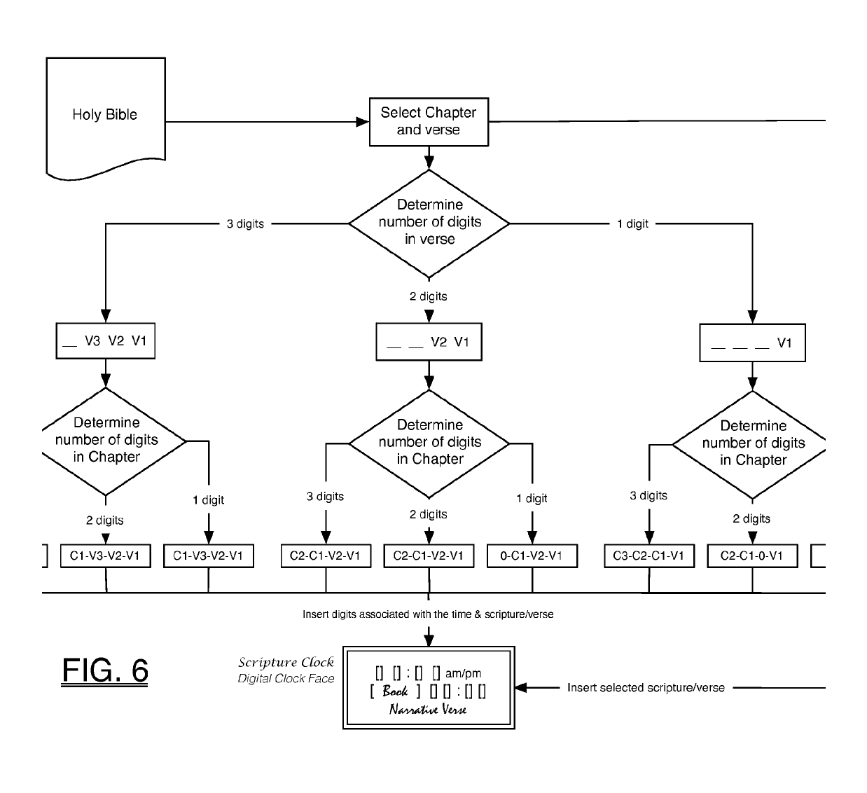

FIG. 6 is a flow chart that illustrates yet still another embodiment of the system and method for the time domain presentation of text data for use with any chapter and verse of the Holy Bible. Generally, the system and method for the time domain presentation of text data provides a plurality steps: selecting a chapter and verse, determining the number of digits associated with the verse defined as a verse count, dispersing the respective verse count from one to three in at least one portion of a linear four-digit array, determining the number of digits associated with the respective chapter defined as a chapter count, dispersing the respective chapter count from one to three in the unfilled portions of the linear four digit array, and simultaneously displaying the four-digit array and the associated Bible verse. Particularly, for example, at 1:15 am, the viewer of the scripture clock timepiece sees not only the digital time (1:15 am), but time in the form of scripture (1 John 1:5), in a direct numerical relationship between the time interval and chapter and verse from the Holy Bible. For each time interval in the 24 hour day (1440), the viewer of the scripture clock timepiece sees not only the digital time, 1440 times per day, but time in the form of scripture (1440 scriptures), in a direct numerical relationship between the time interval and chapter and verse from the Holy Bible.

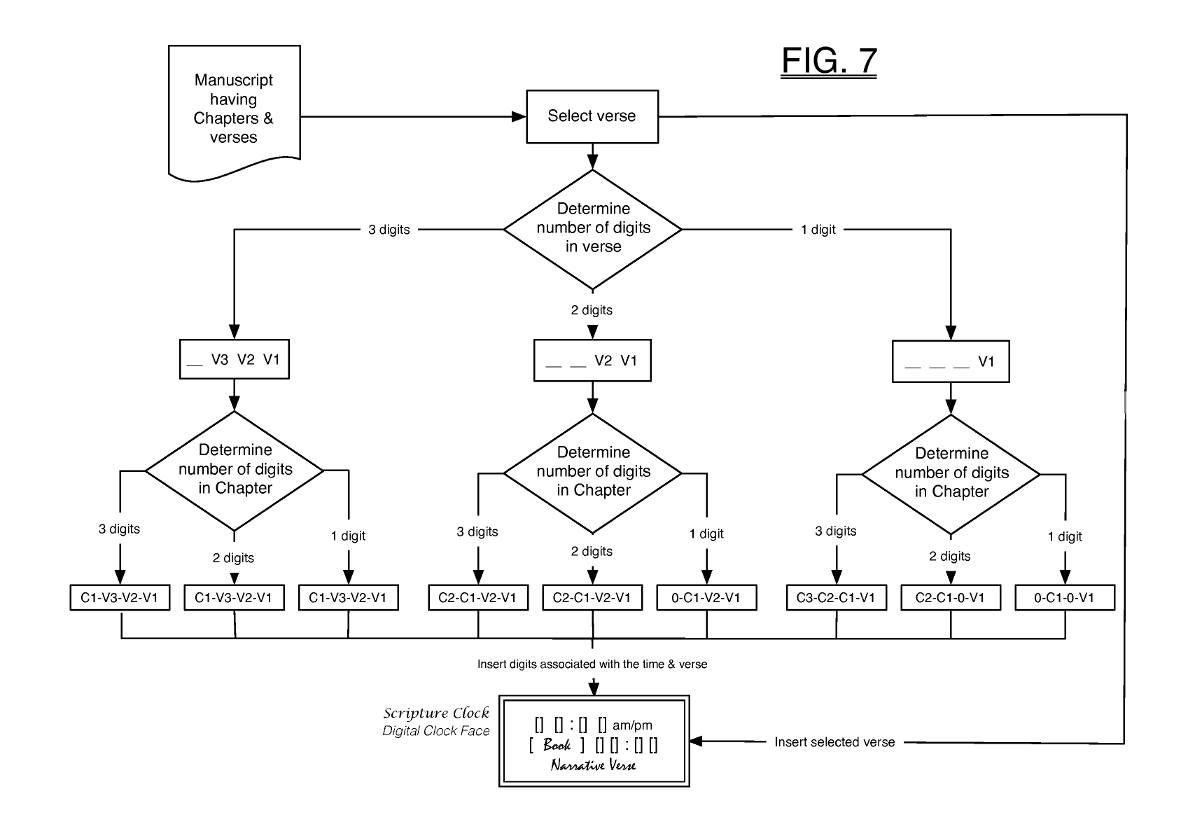

FIG. 7 is a flow chart that illustrates yet still another embodiment of the system and method for the time domain presentation of text data for use with any chapter and verse/paragraph manuscript. Generally, the system and method for the time domain presentation of text data provides a plurality steps: selecting a chapter and verse, determining the number of digits associated with the verse defined as a verse count, dispersing the respective verse count from one to three in at least one portion of a linear four-digit array, determining the number of digits associated with the respective chapter defined as a chapter count, dispersing the respective chapter count from one to three in the unfilled portions of the linear four digit array, and simultaneously displaying the four-digit array and the associated verse.

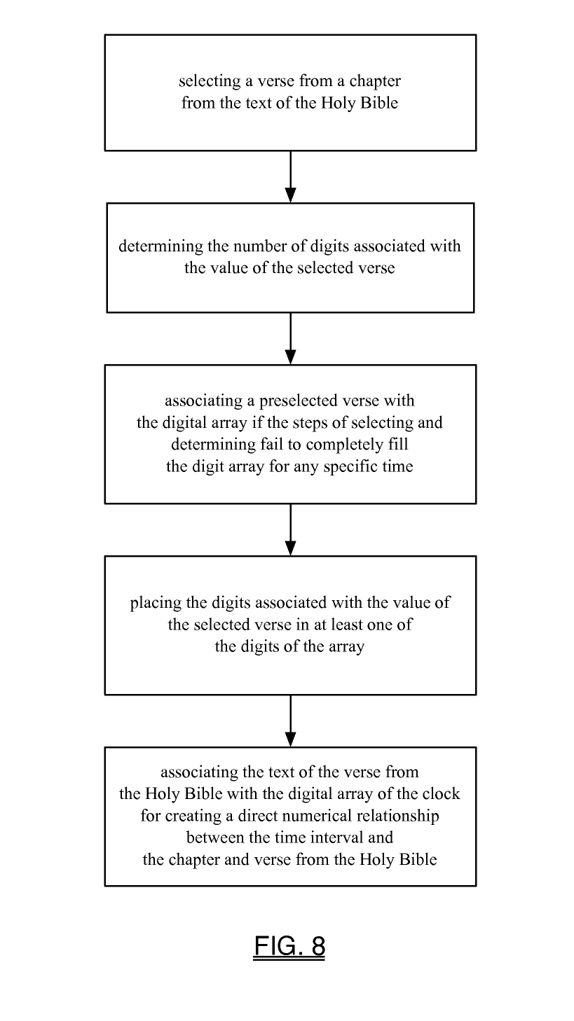

FIG. 8 is a flow chart that illustrates still another embodiment of the system and method for the time domain presentation of text data for use with the Holy Bible. The methodology is as follows. A verse from a chapter is selected from the Holy Bible. The number of digits associated with the value of the selected verse is determined. If the steps of selecting and determining fail to completely fill a digital array for any specific time, a preselected verse is used with the digital array. The digits associated with the value of the selected verse is placed in at least one of the digits of the array. The text of the verse is associated with the digital array of the clock for creating a unique combination of verse and time.

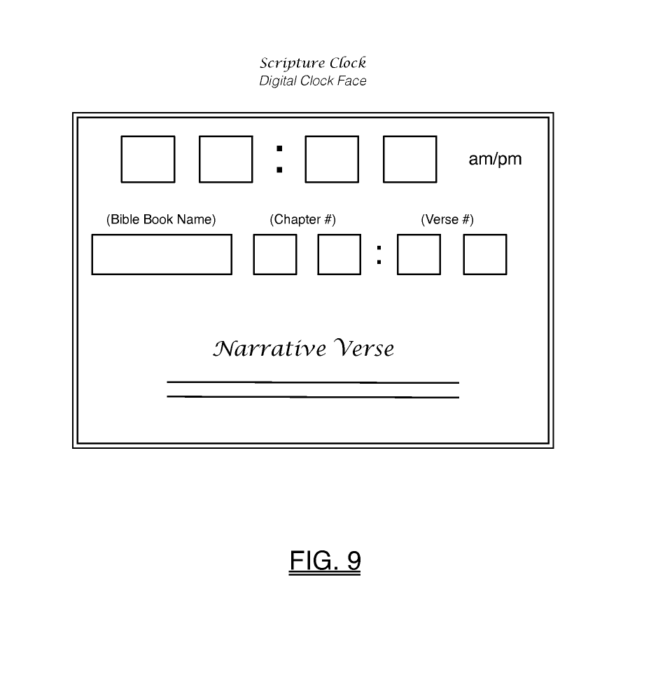

FIG. 9 illustrates another display of the system and method of the present disclosure with respect to the direct numerical relationship between the time interval, on one hand, and the chapter and verse from the Holy Bible, on the other hand. FIG. 9 includes the Bible Book Name on the digital clock face of the scripture clock timepiece.

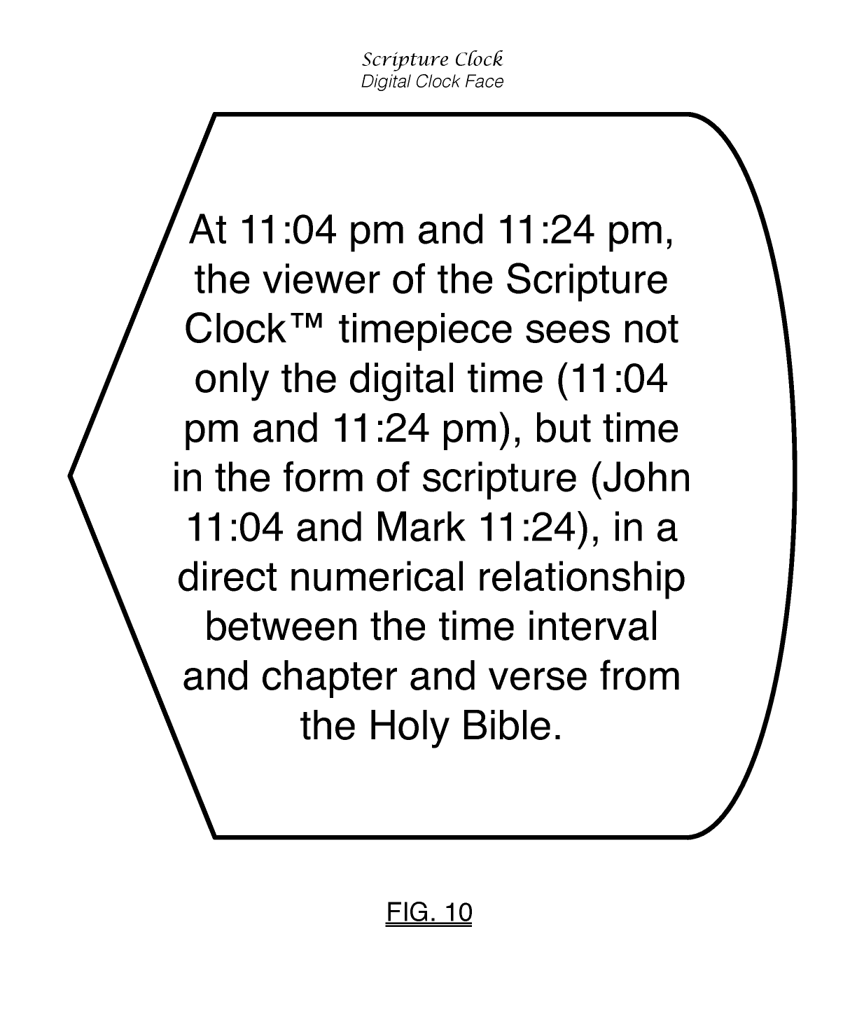

FIG. 10 illustrates a display explaining the time and text data presented by the system and method of the present disclosure with respect to the direct numerical relationship between the time interval, on one hand, and the chapter and verse from the Holy Bible, on the other hand.

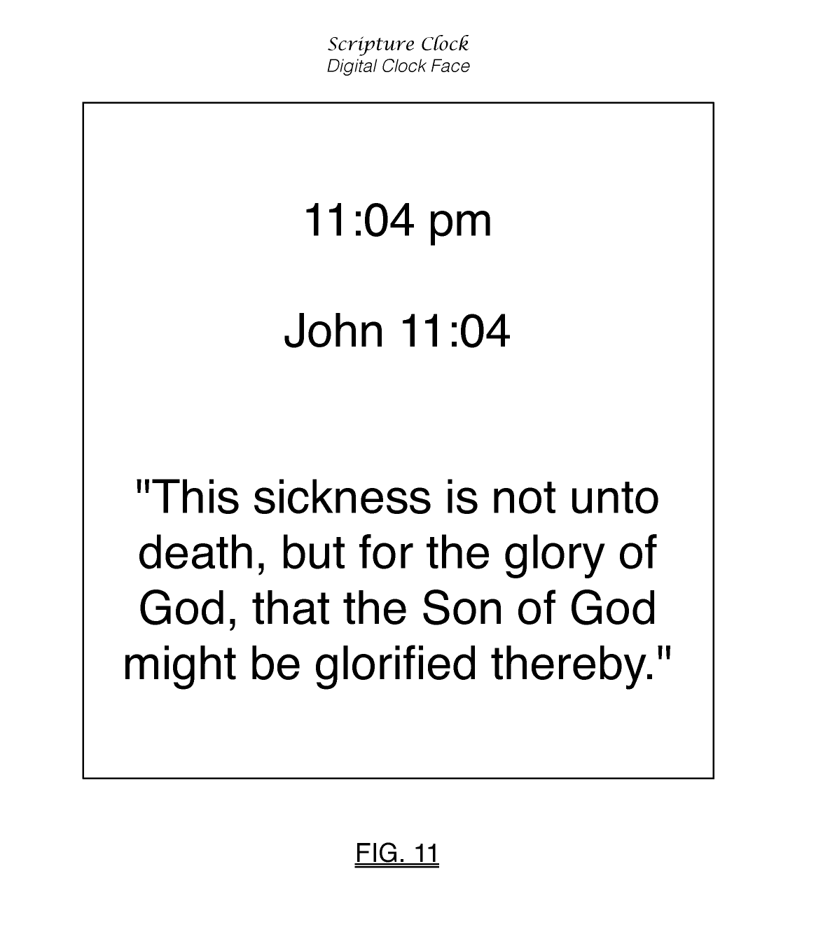

FIG. 11 illustrates another display of the system and method of the present disclosure with respect to the direct numerical relationship between the time interval, on one hand, and the chapter and verse from the Holy Bible, on the other hand.

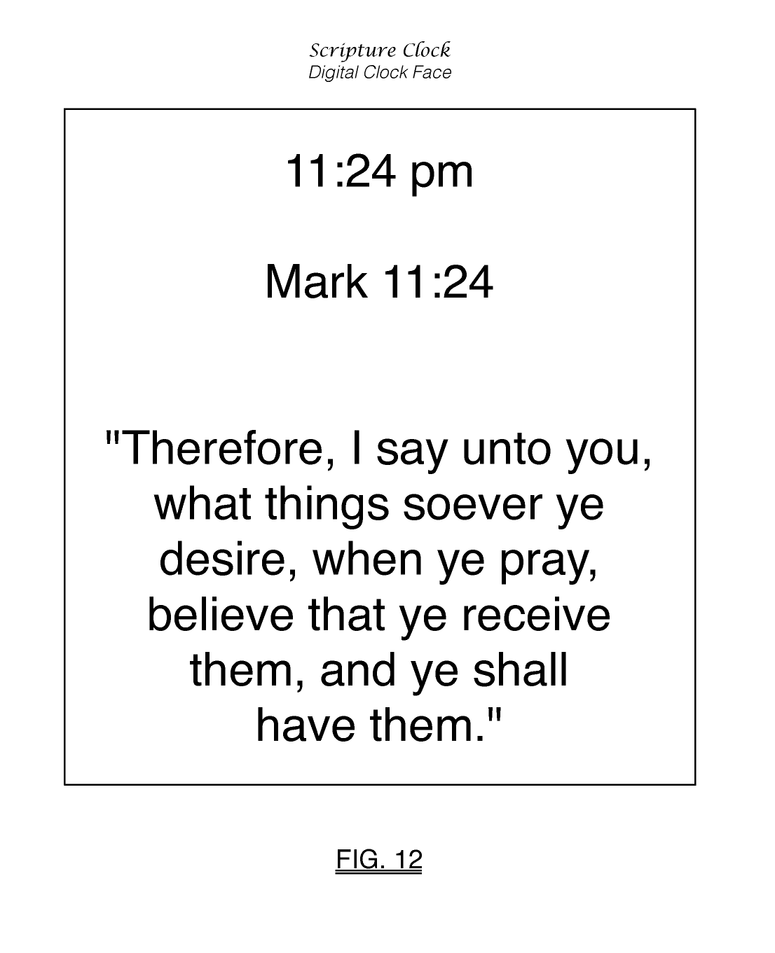

FIG. 12 illustrates yet another display of the system and method of the present disclosure with respect to the direct numerical relationship between the time interval, on one hand, and the chapter and verse from the Holy Bible, on the other hand.

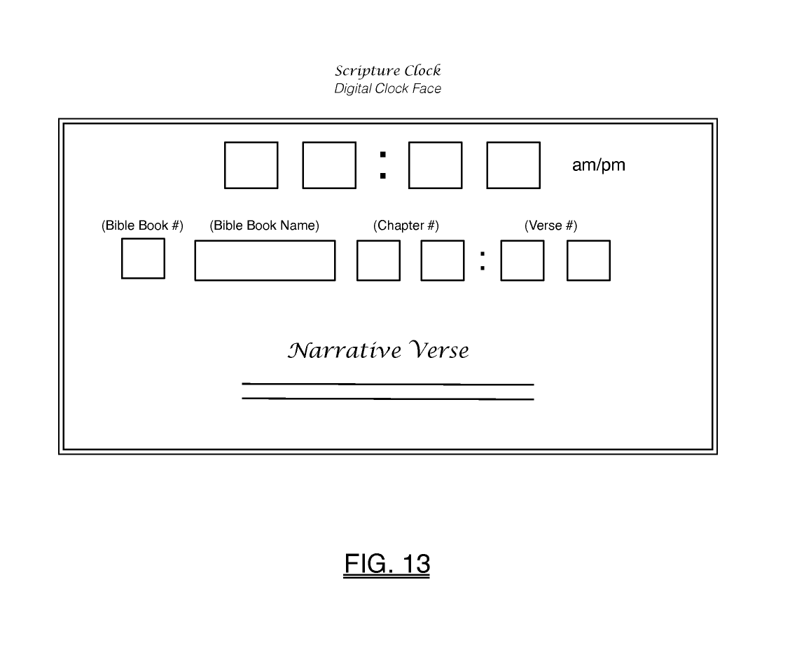

FIG. 13 illustrates a digital clock display of another system and method of the present disclosure with respect to the direct numerical relationship between the time interval, on one hand, and the chapter and verse from the Holy Bible, on the other hand.

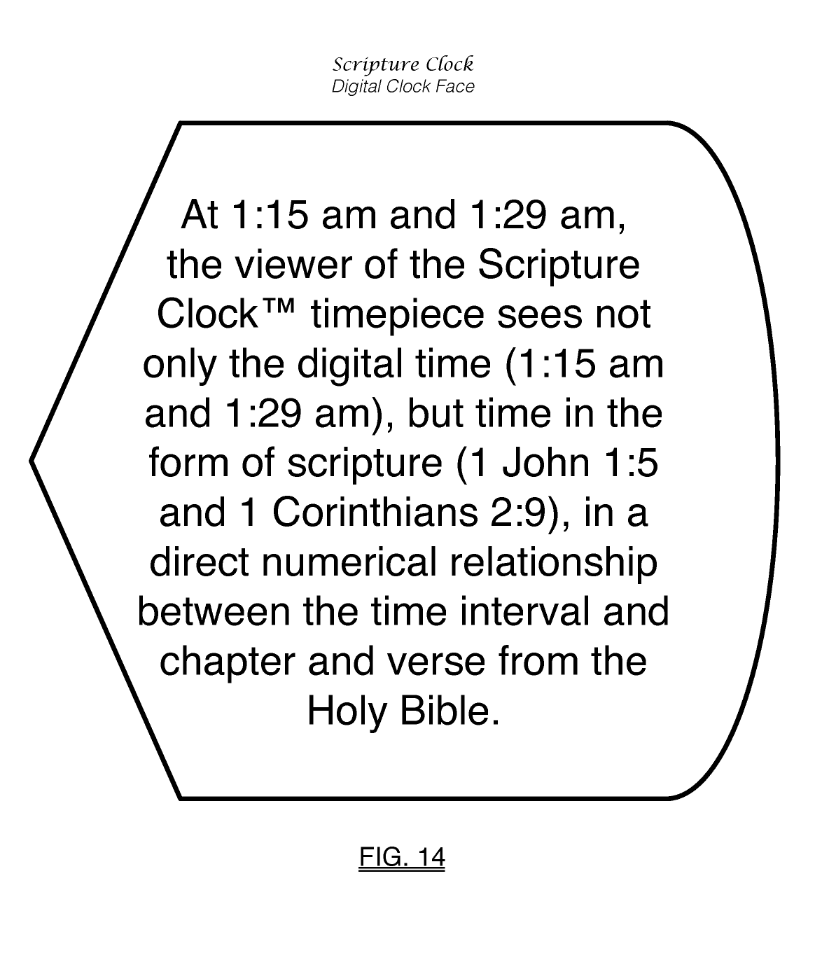

FIG. 14 illustrates a display explaining the time and text data presented by the system and method of the present disclosure with respect to the direct numerical relationship between the time interval, on one hand, and the chapter and verse from the Holy Bible, on the other hand.

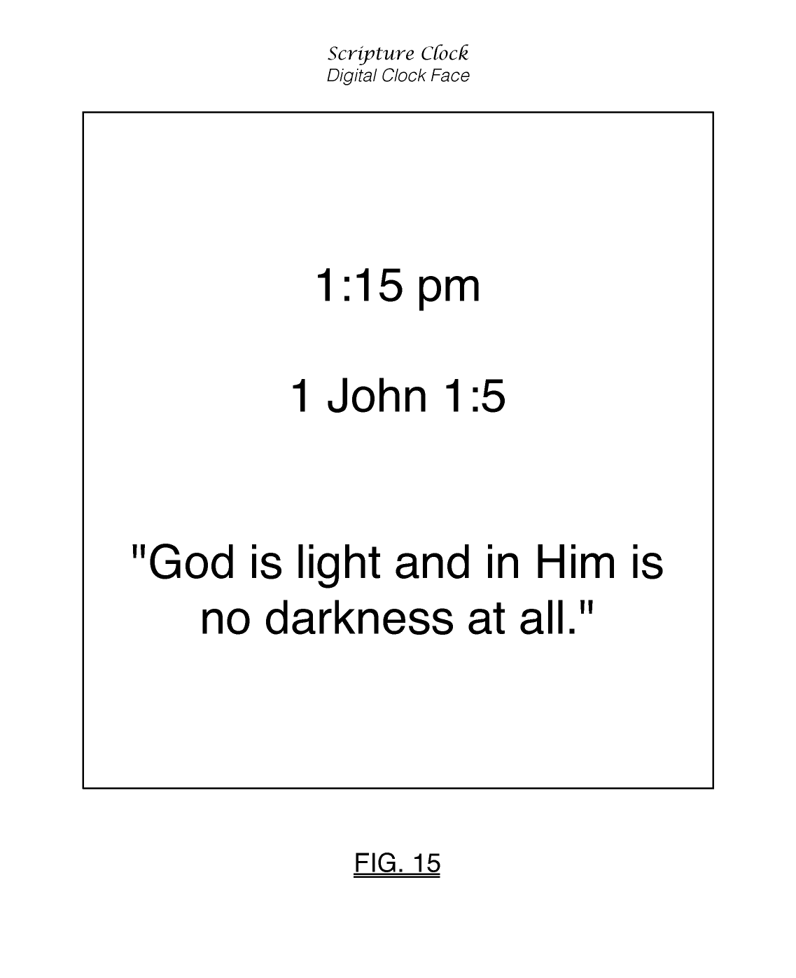

FIG. 15 illustrates another display of the system and method of the present disclosure with respect to the direct numerical relationship between the time interval, on one hand, and the chapter and verse from the Holy Bible, on the other hand.

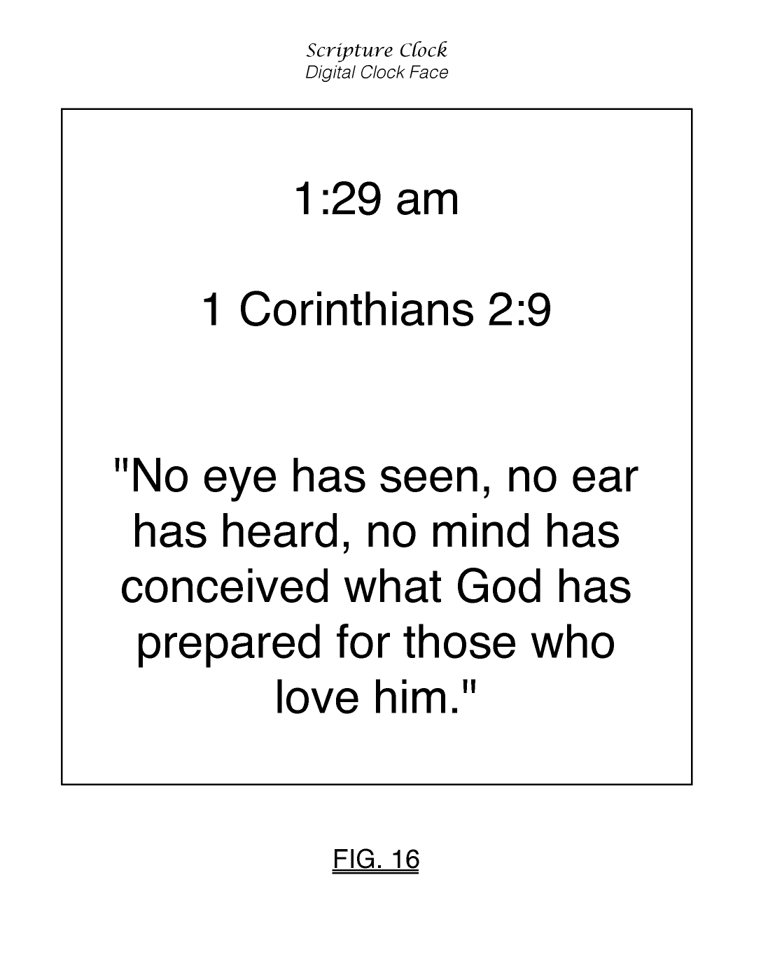

FIG. 16 illustrates yet another display of the system and method of the present disclosure with respect to the direct numerical relationship between the time interval, on one hand, and the chapter and verse from the Holy Bible, on the other hand.

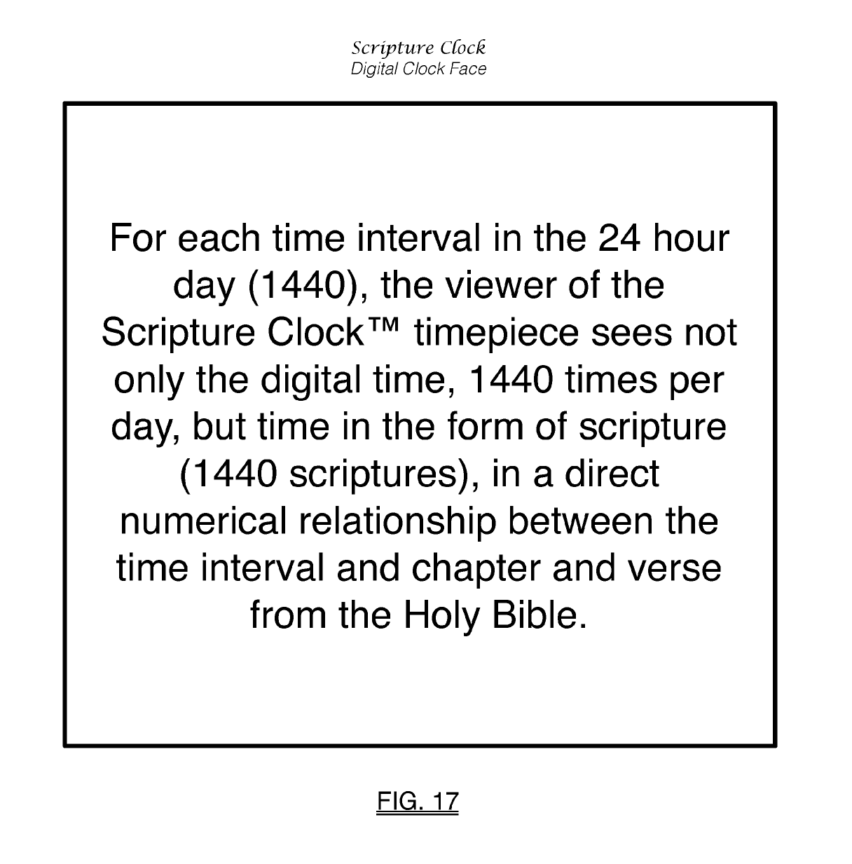

FIG. 17 illustrates a display explaining the time and text data presented by the system and method of the present disclosure with respect to the direct numerical relationship between the time interval, on one hand, and the chapter and verse from the Holy Bible, on the other hand, as well as the relationship of the one-to-one correlation between each interval of time and a specific scripture from the Holy Bible.

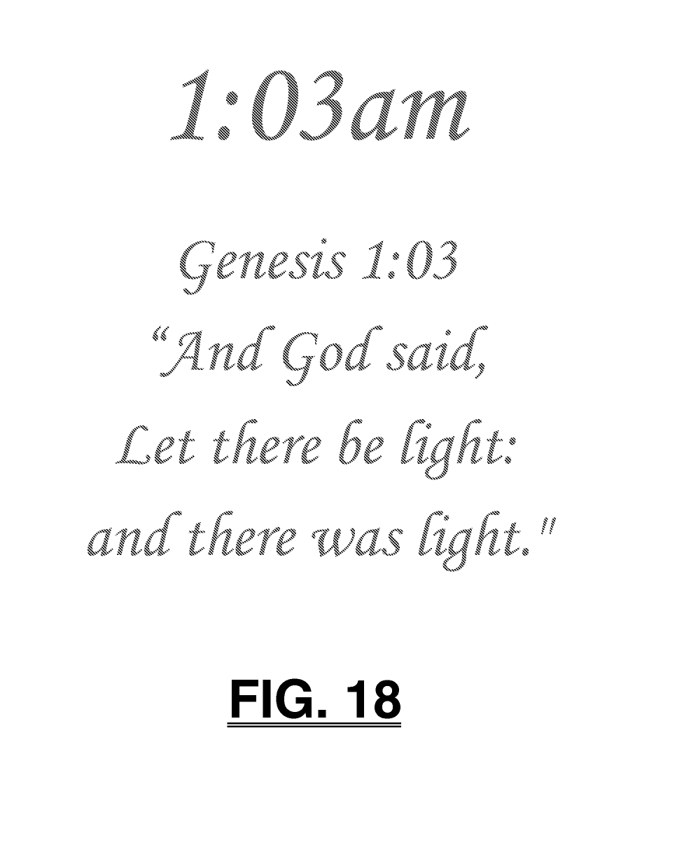

FIG. 18 illustrates a display of time and text data presented by the system and method of the present disclosure with respect to the direct numerical relationship between the time interval, on one hand, and the chapter and verse from the Holy Bible, on the other hand.

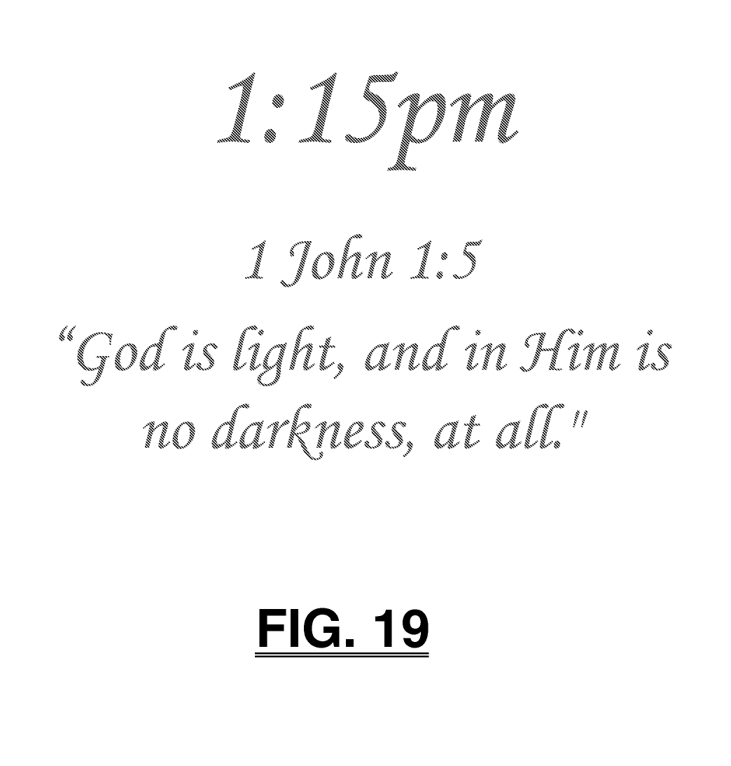

FIG. 19 illustrates yet another display of time and text data presented by the system and method of the present disclosure with respect to the direct numerical relationship between the time interval, on one hand, and the chapter and verse from the Holy Bible, on the other hand.

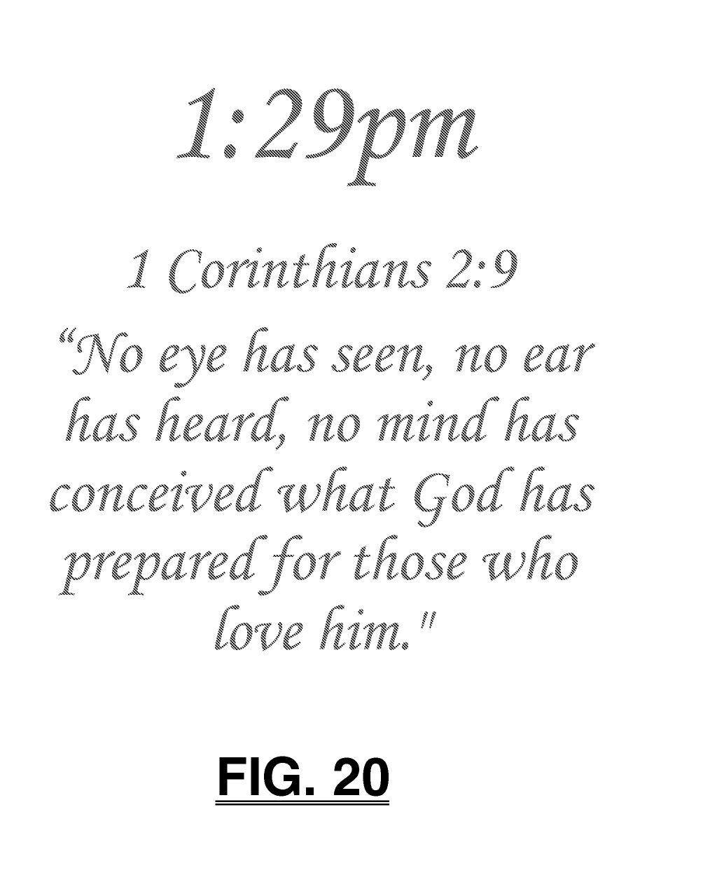

FIG. 20 illustrates yet another display of time and text data presented by the system and method of the present disclosure with respect to the direct numerical relationship between the time interval, on one hand, and the chapter and verse from the Holy Bible, on the other hand.

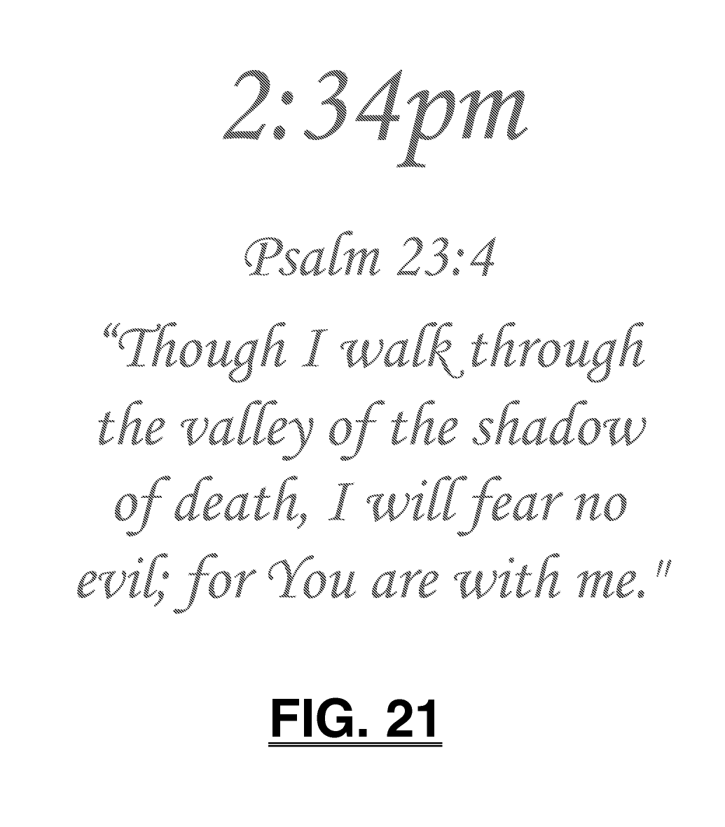

FIG. 21 illustrates another display of time and text data presented by the system and method of the present disclosure with respect to the direct numerical relationship between the time interval, on one hand, and the chapter and verse from the Holy Bible, on the other hand.

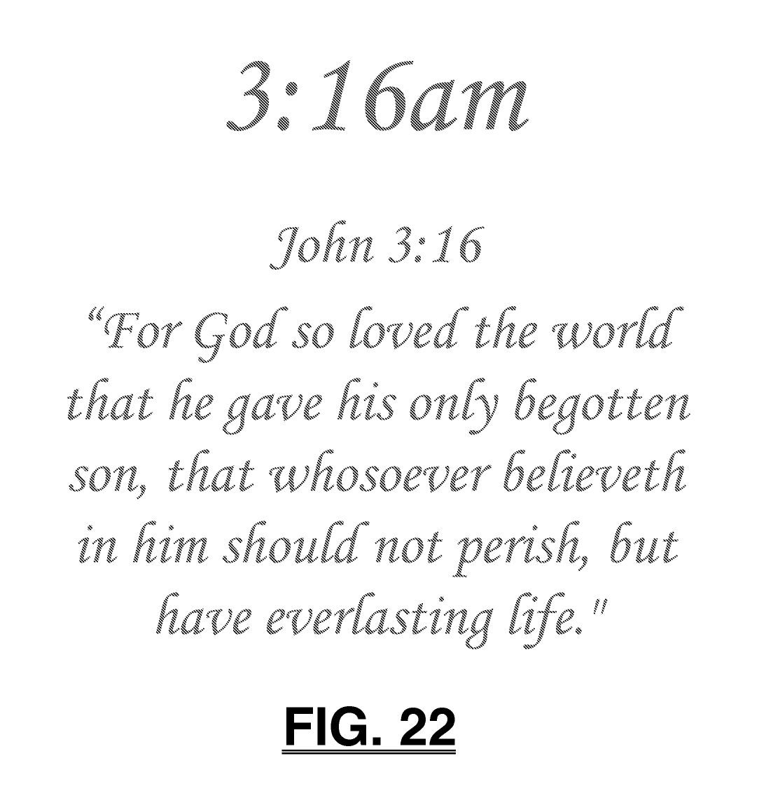

FIG. 22 illustrates another display of time and text data presented by the system and method of the present disclosure with respect to the direct numerical relationship between the time interval, on one hand, and the chapter and verse from the Holy Bible, on the other hand.

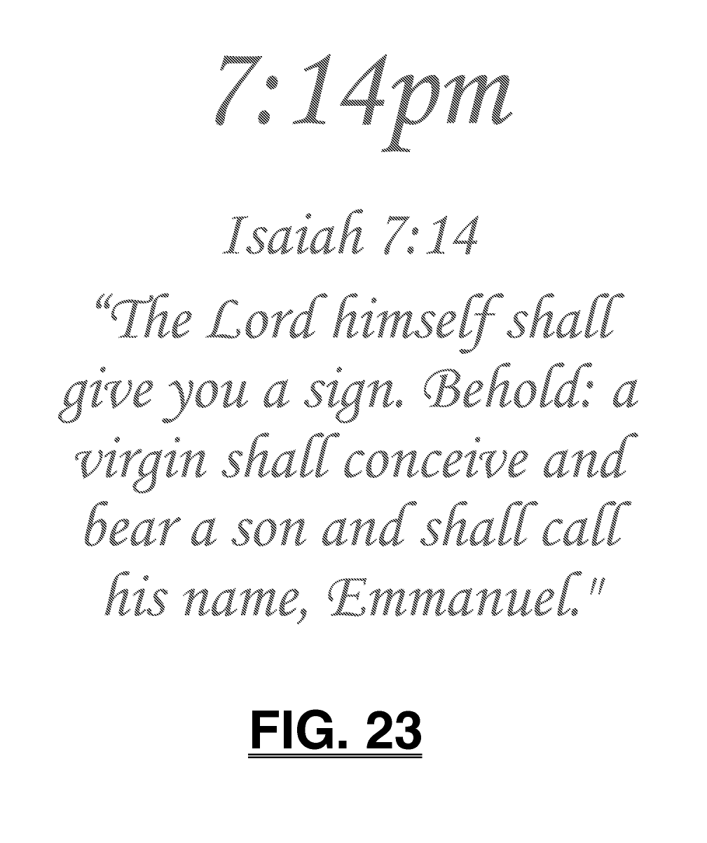

FIG. 23 illustrates yet another display of time and text data presented by the system and method of the present disclosure with respect to the direct numerical relationship between the time interval, on one hand, and the chapter and verse from the Holy Bible, on the other hand.

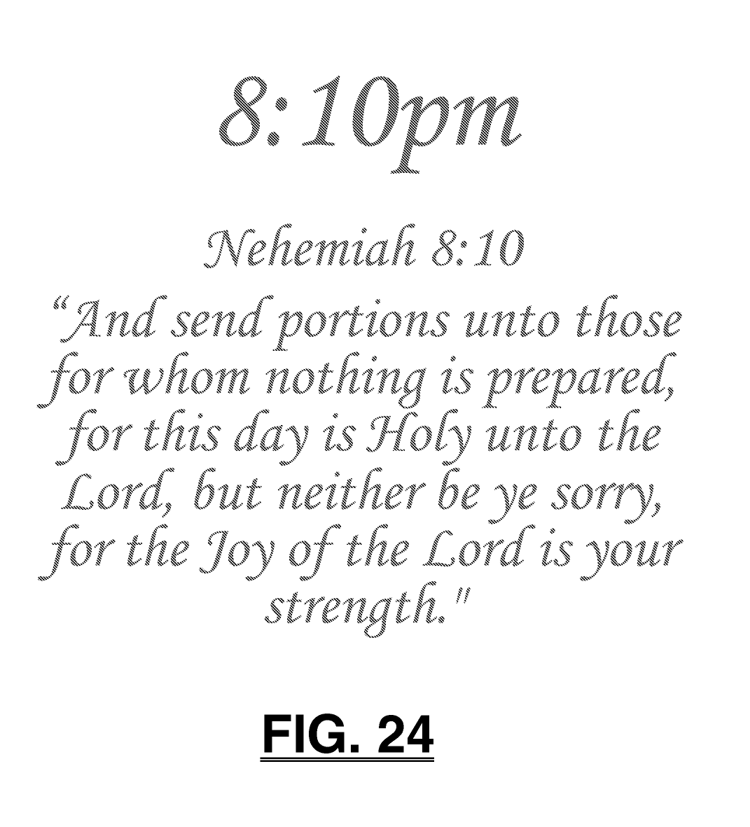

FIG. 24 illustrates still another display of time and text data presented by the system and method of the present disclosure with respect to the direct numerical relationship between the time interval, on one hand, and the chapter and verse from the Holy Bible, on the other hand.

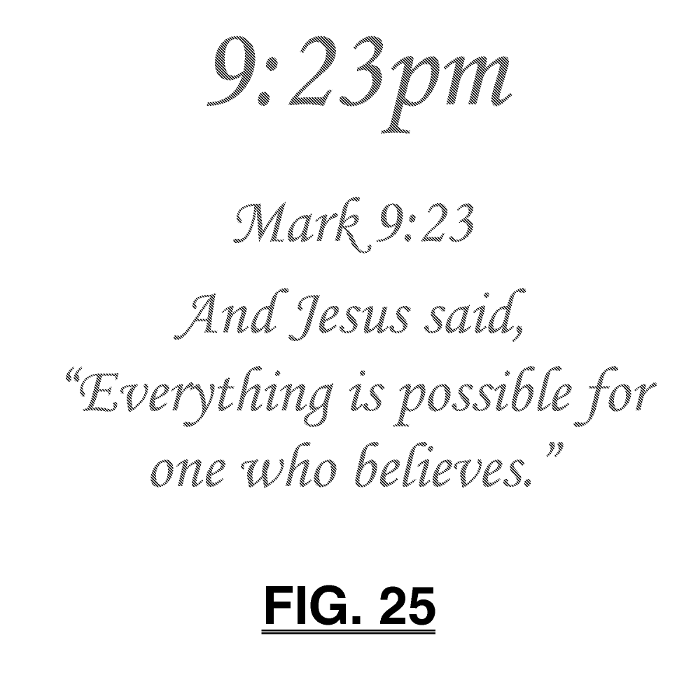

FIG. 25 illustrates still another display of time and text data presented by the system and method of the present disclosure with respect to the direct numerical relationship between the time interval, on one hand, and the chapter and verse from the Holy Bible, on the other hand.

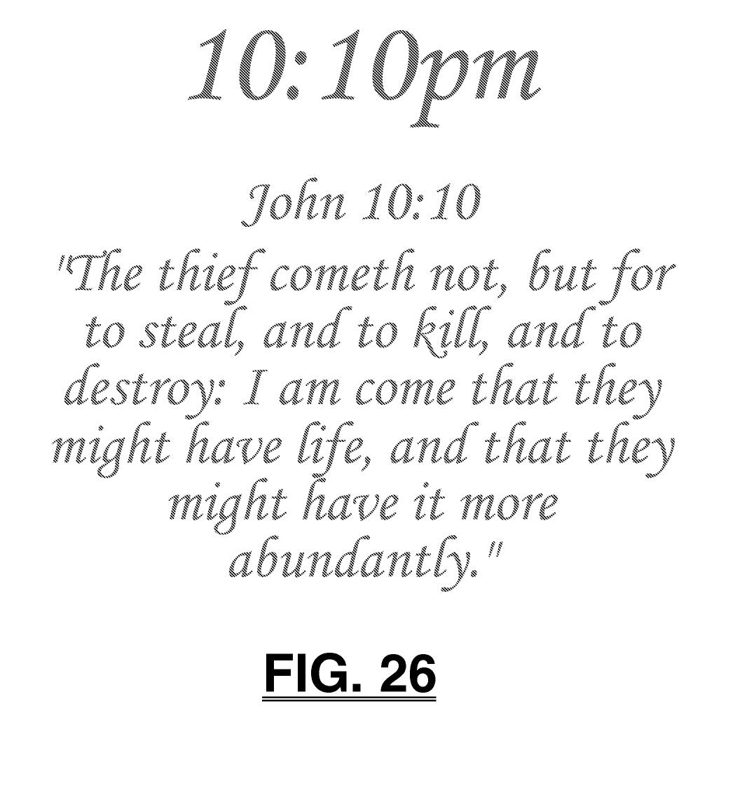

FIG. 26 illustrates still another display of time and text data presented by the system and method of the present disclosure with respect to the direct numerical relationship between the time interval, on one hand, and the chapter and verse from the Holy Bible, on the other hand.

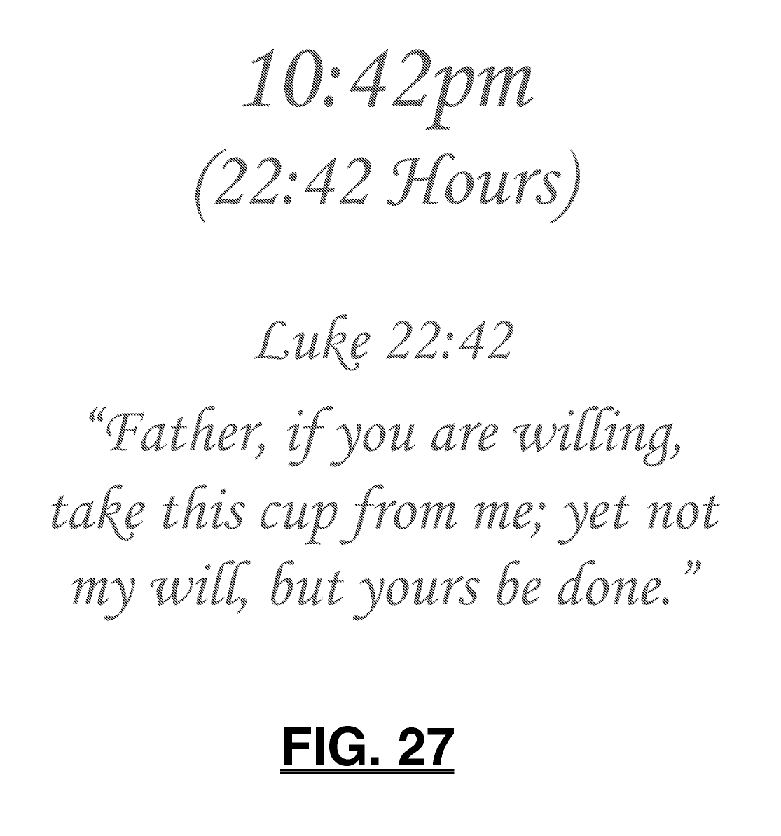

FIG. 27 illustrates a display of time and text data presented by the system and method of the present disclosure with respect to the direct numerical relationship between the time interval, on one hand, and the chapter and verse from the Holy Bible, on the other hand.

From the foregoing description, one of ordinary skill in the art can easily ascertain the essential characteristics of this disclosure, and without departing from the spirit and scope thereof, can make various changes and modifications to adapt the disclosure to various usages and conditions. For example, we do not mean for references such as above, below, left, right, and the like to be limiting but rather as a guide for orientation of the referenced element to another element. A person of skill in the art should understand that certain of the above-described structures, functions, and operations of the above-described embodiments are not necessary to practice the present disclosure and are included in the description simply for completeness of an exemplary embodiment or embodiments. In addition, a person of skill in the art should understand that specific structures, functions, and operations set forth in the above-described referenced patents and publications can be practiced in conjunction with the present disclosure, but they are not essential to its practice.

The invention can be embodied in other specific forms without departing from its spirit or essential characteristics. A person of skill in the art should consider the described embodiments in all respects only as illustrative and not restrictive. The scope of the invention is, therefore, indicated by the appended claims rather than by the foregoing description. A person of skill in the art should embrace, within their scope, all changes to the claims which come within the meaning and range of equivalency of the claims. Further, we hereby incorporate by reference, as if presented in their entirety, all published documents, patents, and applications mentioned herein.

1. An improved process of transferring electronic data comprising numerically coded texts associated corresponding to time of day, the process comprising
an electronic clock initiated transfer of electronic data to a processor operatively connected to an electronic database, the data comprising a four digit value of time of day corresponding to a time of day generated by the clock, each digit itself comprising a numerical value to an electronic database; wherein
A. a first digit as read from left to right consists of an integer value of 0, 1, or 2;
B. a second digit as read from left to right consists of an integer value of 0 to 9;
C. a third digit as read from left to right consists of an integer value of 0 to 9;
D. a fourth digit as read from left to right consists of an integer value of 0 to 9; and
wherein the database comprises electronic data; the electronic data itself comprising at least 100 numerically coded texts; the numerically coded texts each comprising a four digit numerical value; wherein
A. a first digit associated with a text as read from left to right consists of a numerical value of 0, 1, or 2;
B. a second digit associated with the same text as read from left to right consists of a numerical value of 0 to 9;
C. a third digit associated with the same text as read from left to right consists of a numerical value of 0 to 9;
D. a fourth digit associated with the same text as read from left to right consists of a numerical value of 0 to 9; and
a processor initiated transfer of electronic data comprising selecting a numerically coded text from the database to an electronic graphical interface, the numerically coded text being the same value as the four digit time of day, and wherein the text is displayed on the electronic graphical display, and wherein the processor selects the numerically coded texts during the time of day generated by the clock.

2. The process of claim 1, wherein the numerically coded texts comprises a book of a Bible or Book of Mormon (BOM), a chapter of the Bible or BOM within said book and a verse of the Bible or BOM within said chapter.

3. The process of claim 2, wherein books of the Bible or BOM correspond to a numerical value of 0, 1, 2, 3 or 4 and wherein:
A. books of the Bible or BOM having numerical value of 1 are: 1 Kings, 1 Chronicles, 1 Corinthians, 1 Thessalonians, 1 Timothy, 1 Peter, 1 John, 1 Esdras, 1 Maccabees, and 1 Nephi;
B. books of the Bible or BOM having an integer value of 2 are: 2 Kings, 2 Chronicles, 2 Corinthians, 2 Thessalonians, 2 Timothy, 2 Peter, 2 John, 2 Esdras, 2 Maccabees, and 2 Nephi;
C. books of the Bible or BOM having an integer value of 3 are: 3 John, 3 Maccabees, and 3 Nephi;
D. books of the Bible or BOM having an integer value of 4 are: 4 Maccabees and 4 Nephi;
E. all other books of the bible have an integer value of 0.

4. The process of claim 3, wherein when the processor selects a book, chapter and verse combination from the electronic database to associate this combination with the time of day, the processor searches for:
A. a book of the Bible or BOM having a numerical value of a 1 or a 2 and further wherein
a. if the book has a numerical value of 1, then the second digit of the four digit value of time is a first digit of any numerical chapter of the book having less than three digits and wherein:
i. if the chapter of the book is a single digit chapter, then
1. the numerical value of the single digit chapter is 1, 2, 3, 4, 5, 6, 7, 8, or 9; and
2. the third and fourth digits of the four digit value of time are selected from a two digit verse of the book, the first digit of the two digit verse having a numerical value of 1, 2, 3, 4, or 5 and the second digit having any numerical value; or
ii. if the numerical chapter of the book is a two digit chapter, then
1. the first digit of the two digit chapter has a numerical value of 1, 2, 3, 4, 5, 6, 7, 8, or 9;
2. the second digit of the two digit chapter, corresponding to the third digit of the four digit value of time has a numerical value of 0, 1, 2, 3, 4 or 5; and
3. the fourth digit of the four digit value of time is a single digit verse of said chapter having a numerical value of 1, 2, 3, 4, 5, 6, 7, 8 or 9; or
b. if the book has a value of 2, then the second digit of the four digit value of time is a first digit of any numerical chapter of the book having less than three digits and wherein:
i. if the numerical chapter of the book is a single digit chapter, then
1. the numerical value of the single digit chapter is 1, 2, or 3;
2. the third and fourth digits of the four digit value of time are selected from a two digit verse, the first digit of the two digit verse having a numerical value of 1, 2, 3, 4, or 5; and
3. the second digit of the two digit verse has any single digit numerical value; or
ii. if the numerical chapter of the book is a two digit chapter, then
1. the first digit of the two digit chapter has a numerical value of 1, 2, or 3;
2. the second digit of the two digit chapter, corresponding to the third digit of the four digit value of time has a numerical value of 0, 1, 2, 3, 4 or 5; and
3. the fourth digit of the four digit value of time is a single digit verse of said chapter having a numerical value of 1, 2, 3, 4, 5, 6, 7, 8, or 9; or
B. a book of the Bible or BOM having a value of 0 wherein:
a. a chapter and verse selection correspond to a four digit value of time and the chapter has at least a first digit having a numerical value of 1 or 2 corresponding to the first digit of the four digit value of time, and wherein:
i. if the chapter is a single digit chapter, then the next three digits correspond to a three digit verse of the chapter, with the proviso that if the single digit has a numerical value of 2, then the first digit of the verse has a numerical value of 1, 2, or 3, and the second digit of the verse has a numerical value of 1, 2, 3, 4 or 5;
ii. if the chapter is a two digit chapter, then
1. if the first digit of the two digit chapter has a numerical value of 1, then the second digit of the chapter is any digit and
2. the next two digits correspond to a two digit verse of the chapter, the wherein the first digit of the two digit verse has a numerical value of 1, 2, 3, 4, or 5;
iii. if the chapter is a three digit chapter, then:
1. the first digit of the chapter has a numerical value of 1;
2. the second digit of the chapter has a numerical value of 1, 2, 3, 4, or 5;
3. the third digit of the chapter has a numerical value of 1, 2, 3, 4 or 5; and
4. the fourth digit corresponds to a single digit verse of the chapter having a numerical value of 1, 2, 3, 4, 5, 6, 7, 8, or 9
b. the first digit is a 0 value of the book and a chapter and verse selection correspond to a three additional digits of the value of time wherein:
i. the chapter is a single digit chapter and has a numerical value of 1, 2, 3, 4, 5, 6, 7, 8 or 9; and the next two digits correspond to a two digit verse of the chapter, the wherein the first digit of the two digit verse has a numerical value 1, 2, 3, 4, or 5 and the second digit of the two digit verse has any single digit value; or
ii. the chapter is a two digit chapter, and wherein
1. the first digit of the chapter is a 1, 2, 3, 4, 5, 6, 7, 8, or 9
2. the second digit of the chapter is a 1, 2, 3, 4, or 5; and
3. the third digit is a single digit verse of the chapter and has a value of 1, 2, 3, 4, 5, 6, 7, 8 or 9;
C. a book of the Bible having a value of 3 or 4 wherein a chapter and verse selection correspond to the next three digits of the four digit value of time, and wherein the chapter is a single digit chapter having a numerical value of 1, 2, 3, 4, or 5 and the verse is a single verse with a numerical value of 1, 2, 3, 4, 5, 6, 7, 8 or 9 and
wherein no combination of values of chapter or verse is selected if said chapter or verse does not exist a selected book.

5. The process of claim 4, wherein the processor searches for texts comprising a combination of numerical values of a book, chapter, and verse corresponding to a subject comprising Jesus's birth during December and presents the texts on the graphical display if the combination of numerical values is able to correspond to the value of time needed.

6. The process of claim 4, wherein the processor searches for texts comprising a combination of numerical values of a book, chapter, and verse corresponding to a subject comprising Jesus's death and resurrection during March or April and presents the texts on the graphical display if the combination of numerical values is able to correspond to the value of time needed.

7. The process of claim 1, wherein the graphical display is an automatic email signature viewed on a computer.

8. The process of claim 1, wherein the graphical display is a display on a website.

9. The process of claim 1, wherein the graphical display is a display on a clock face.

10. The process of claim 1, wherein the graphical display is a display on a phone or watch.
